(19) United States
(12) Patent Application Publication
(10) Pub. No.: US 2017/0068227 A1
(43) Pub. Date: Mar. 9, 2017

(54) METHOD AND SYSTEM FOR EXTENDING FUNCTIONALITY OF INTER-CONNECTED PRIMARY AND SECONDARY ELECTRONIC APPLIANCES

(71) Applicant: Wipro Limited, Bangalore (IN)

(72) Inventors: Tinku Malayil Jose, Bangalore (IN); Manish Verma, Bangalore (IN)

(21) Appl. No.: 14/930,260

(22) Filed: Nov. 2, 2015

(30) Foreign Application Priority Data
Sep. 3, 2015 (IN) 4669/CHE/2015

(51) Int. Cl. G05B 15/02; H04L 12/28

(52) U.S. Cl. CPC G05B 15/02; H04L 12/2816

(57) ABSTRACT

The present disclosure relates to a method for extending the functionality of a primary electronic appliance interconnected with one or more secondary electronic appliances in a communication network. In an embodiment a functionality detection unit is configured in each of the electronic appliances. The functionality detection unit identifies functions, data and properties of the primary electronic appliance and also identifies the functions, data and properties of the one or more secondary electronic appliances. The functionality detection unit determines similarity in the functions the one or more properties and data corresponding to the primary electronic appliance and the one or more secondary electronic appliances and based on the similarity extends the functionality of the primary electronic appliance.

This application claims the benefit of Indian Patent Application Serial No. 4669/CHE/2015 filed Sep. 3, 2015, which is hereby incorporated by reference in its entirety.

### FIELD

The present subject matter is related in general to electronic appliances, and more particularly, but not exclusively to a method and system for extending functionality of a primary electronic appliance inter-connected with one or more secondary electronic appliances.

### BACKGROUND

Generally, the smart home network allows electronic appliances to form an intelligent system and provide users with an automated living environment. The electronic appliances in the smart home network include, but are not limited to, a refrigerator, an air conditioner, a heating unit, an air cooler, home security systems, for example security locks of gates and doors, gas leakage detector, lighting. These electronic appliances are controlled by a centralized gateway. The centralized gateway may be implemented in numerous ways and provides a central point for building the home network.

With the advent of cost effective and high performance system on chip (SOC's), most of the electronic appliances at home are capable of handling functionality/operation much beyond what it is primarily intended to do. However, these electronic appliances are not using its capabilities which will help in creating an adaptive smart home to provide more value to the users. For example, air quality sensor stepping up to detect gas leak in case of failure of the gas leakage detector. One of the root cause for the same is the inability of the electronic appliance to explore its capability as well as the capability of other electronic appliances in the smart home network.

The issues mainly faced in the existing electronic appliances are that they are not capable to handle additional functionalities beyond which they are intended to do or enhance its functionalities and also compare itself with another device and start performing functionality of the secondary device if it has the required resources.

### SUMMARY

Disclosed herein is a method and system for extending functionality of an electronic appliance. This is achieved by using a functionality detection unit which is incorporated in the electronic appliance. The functionality detection unit determines whether the electronic appliance is capable of performing one or more secondary functionalities or not based on the comparison of data, properties and functions of the electronic appliance with data, properties and functions of other electronic appliances in the communication network.

Accordingly, the present disclosure relates to a method for extending the functionality of a primary electronic appliance, inter-connected with one or more secondary electronic appliances in a communication network. The method comprises identifying by a functionality detection unit configured in the electronic appliance, one or more functions associated with the primary electronic appliance and information associated with one or more properties and data required for performing the one or more functions associated with the primary electronic appliance. Further, the functionality detection unit obtains one or more functions associated with the one or more secondary electronic appliances and information associated with one or more properties and data required for performing the one or more functions associated with the one or more secondary electronic appliances. The method further comprises comparing the information associated with one or more properties and the data required for performing the one or more functions associated with the primary electronic appliance with the information associated with one or more properties and data required for performing the one or more functions, associated with the one or more secondary electronic appliances. Based on the comparison, the functionality detection unit determines similarity in the information associated with one or more properties and the data required for performing the one or more functions associated with the primary electronic appliance with the information associated with one or more properties and data required for performing the one or more functions associated with the one or more secondary electronic appliances. Thereafter, the functionality detection unit invokes the one or more functions associated with the secondary electronic appliance based on the similarity thereby extending functionality of the primary electronic appliance.

Further, the present disclosure relates to a functionality detection unit for extending functionality of a primary electronic appliance inter-connected with rest of electronic appliances in a communication network. The functionality detection unit comprises a processor and a memory communicatively coupled to the processor, wherein the memory stores processor executable instructions, which, on execution, causes the processor to identify one or more functions associated with the primary electronic appliance and information associated with one or more properties and data required for performing the one or more functions associated with the primary electronic appliance. The processor further obtains one or more functions associated with the one or more secondary electronic appliances and information associated with one or more properties and data required for performing the one or more functions associated with the one or more secondary electronic appliances. Thereafter, the processor compares the information associated with one or more properties and data required for performing the one or more functions associated with the primary electronic appliance with the information associated with one or more properties and data required for performing the one or more functions associated with the one or more secondary electronic appliances. Based on the comparison, the processor determines similarity in the information associated with one or more properties and data required for performing the one or more functions associated with the primary electronic appliance with the information associated with one or more properties and data required for performing the one or more functions associated with the one or more secondary electronic appliances. The processor invokes the one or more functions associated with the secondary electronic appliances based on the similarity thereby extending functionality of the primary electronic appliance.

Furthermore, the present disclosure relates to a non-transitory computer readable medium including instructions stored thereon that when processed by at least one processor cause a functionality detection unit configured in a primary electronic appliance inter-connected with one or more secondary electronic appliances in a communication network to identify one or more functions associated with the primary electronic appliance and information associated with one or more properties and data required for performing the one or more functions associated with the primary electronic appliance. The instructions further causes the functionality detection unit to obtain one or more functions associated with the one or more secondary electronic appliances and information associated with one or more properties and data required for performing the one or more functions associated with the one or more secondary electronic appliances. Thereafter, the functionality detection unit compares the information associated with one or more properties and data required for performing the one more functions associated with the primary electronic appliance with the information associated with one or more properties and data required for performing the one or more functions associated with the one or more secondary electronic appliances. Based on the comparison, the functionality detection unit determines similarity in the information associated with one or more properties and data required for performing the one or more functions associated with the primary electronic appliance with the information associated with one or more properties and data required for performing the one or more functions associated with the one or more secondary electronic appliances. The functionality detection unit invokes the one or more functions associated with the secondary electronic appliance based on the similarity thereby extending functionality of the primary electronic appliance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment illustrating a method for extending functionality of a primary electronic appliance for performing one or more secondary functionalities in accordance with some embodiments of the present disclosure;

FIG. 2a shows a block diagram illustrating a functionality detection unit in accordance with some embodiments of the present disclosure;

FIG. 2b shows a detailed block diagram illustrating a functionality detection unit in accordance with some embodiments of the present disclosure;

FIG. 3a shows a sequence diagram illustrating a method of providing support for performing the secondary functionalities by a primary electronic appliance in accordance with some exemplary embodiments of the present disclosure; and

FIG. 3b shows a sequence diagram illustrating a method for extending the primary functionality of the primary electronic appliance in accordance with some exemplary embodiments of the present disclosure;

FIG. 4 illustrates an exemplary flowchart showing the method for performing secondary functionalities of one or more electronic appliances in accordance with some embodiments of present disclosure; and

FIG. 5 illustrates a block diagram of an exemplary electronic appliance for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

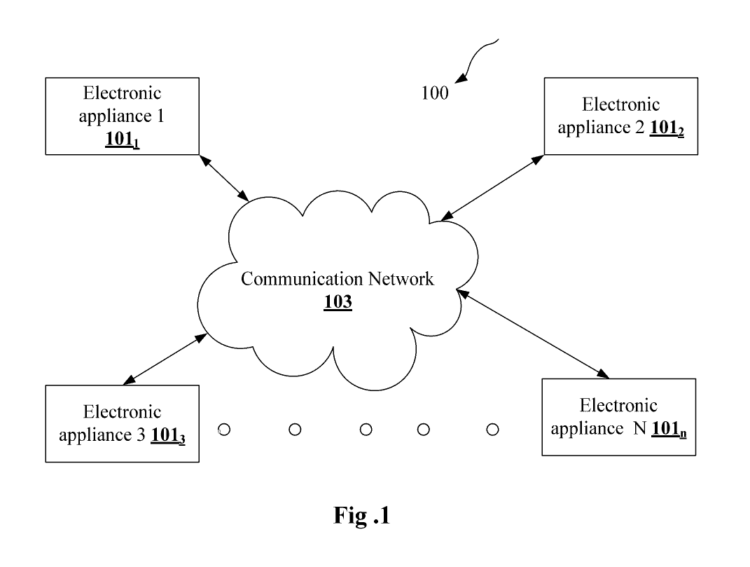

FIG. 1 shows an exemplary environment illustrating a method for extending the functionality of a primary electronic appliance for performing one or more secondary functionalities in accordance with some embodiments of the present disclosure.

As shown in FIG. 1, the environment 100 comprises one or more electronic appliances, electronic appliance 1 1011, electronic appliance 2 1012 to electronic appliance N 101n (collectively referred as electronic appliances 101) interconnected through a communication network 103. As an example, the electronic appliance 1 1011 may be referred as a primary electronic appliance and the electronic appliances 2 1012 to electronic appliance N 101n may be referred as secondary electronic appliances.

As an example, the electronic appliances 101, may include, but not limited to, a refrigerator, lighting systems, security lock of gates and doors, an air cooler, a gas detector and an air quality sensor. The communication network 103 may include, but not limited to, a wired communication network 103, a wireless communication network 103 and a combination thereof. In an embodiment, each of the electronic appliances 101 is configured with a functionality detection unit (not shown explicitly in FIG. 1). The functionality detection unit is configured to extend functionality of the electronic appliances 101. As an example, if the electronic appliance 101 is an air cooler, one of the functionality of the air cooler is to condition the air. The functionality detection unit configured in the air cooler determines whether the functionality of the air cooler can be extended to perform the secondary functionalities or not. As an example, the secondary functionality may be to reduce the humidity of the air in a particular area which is one of the functions of the air conditioner.

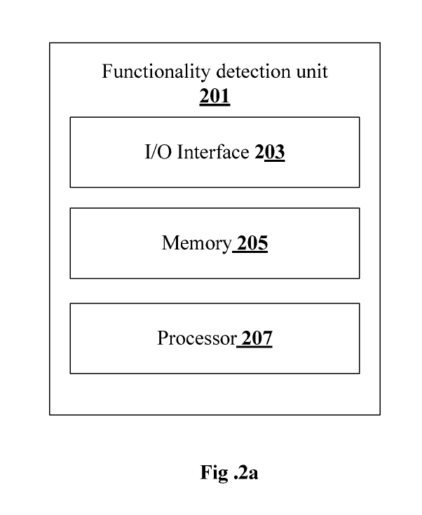

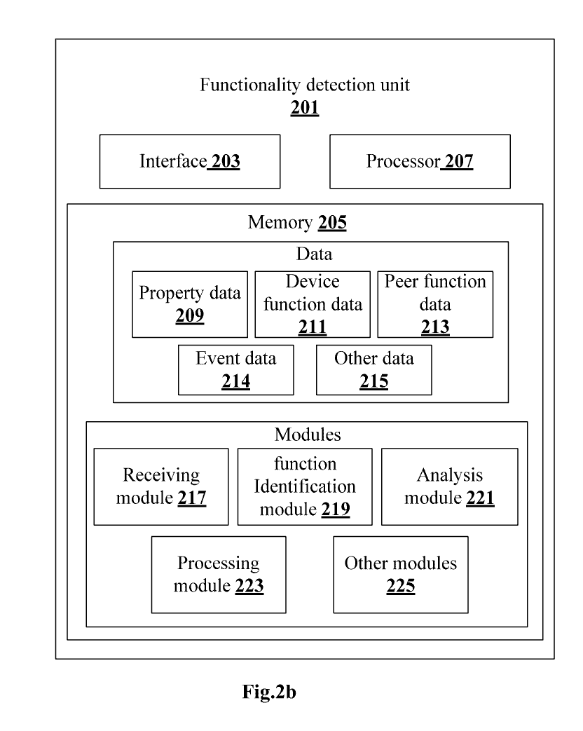

FIG. 2a shows a block diagram illustrating a functionality detection unit 201 in accordance with some embodiments of the present disclosure.

As shown in FIG. 2a, the functionality detection unit 201 comprises an I/O interface 203, a memory 205 and a processor 207. The I/O interface 203 is configured to receive data from the one or more secondary electronic appliances in the communication network 103. The I/O interface 203 is also configured to receive one or more events from the one or more secondary electronic appliances. The received data and the events are stored in the memory 205. The memory 205 is communicatively coupled to the processor 207 wherein the memory 205 stores processor-executable instructions. The processor 207 identifies the one or more functions of the primary electronic appliance. The processor 207 also determines information associated with the one or more properties and the data required by the primary electronic appliance for performing the one or more functions. The processor 207 obtains the one or more functions associated with the one or more secondary electronic appliances and information associated with one or more properties and the data required for performing the one or more functions associated with the one or more secondary electronic appliances. The processor 207 compares the one or more functions, data and properties corresponding to the primary electronic appliance with the one or more functions, data and the properties corresponding to the one or more secondary electronic appliances. Based on the comparison, the processor 207 determines similarity between the one or more functions, data and properties corresponding to the primary electronic appliance and the one or more functions, data and properties corresponding to the one or more secondary electronic appliances 101. Based on the similarity of the functions, data and the properties, the processor 207 invokes the functions associated with the one or more secondary electronic appliance for extending the functionality of the primary electronic appliance.

Further, the processor 207 obtains processing logic to perform the one or more secondary functionalities. In an embodiment, the processing logic may be preconfigured in the primary electronic appliance or retrieved from the one or more secondary electronic appliances.

In an embodiment, the functions are invoked upon determining the inefficiency of the primary electronic appliance for performing the one or more functions. As an example, the inefficiency is detected using parameters, include, but are not limited to, energy consumption, processing capacity, storage capacity and network resources.

FIG. 2b shows a detailed block diagram illustrating a functionality detection unit 201 in accordance with some embodiments of the present disclosure.

In one implementation, the functionality detection unit 201 receives data from the primary electronic appliance in which the functionality detection unit 201 is configured, and the one or more secondary electronic appliances. The functionality detection unit 201 may also receive one or more events from the one or more secondary electronic appliances 101. In an embodiment, the data includes property data 209, device function data 211, peer device function data 213, event data 214 and other data 215. In the illustrated FIG. 2b, one or more modules stored in the memory 205 are described herein in detail.

In one embodiment, the data may be stored in the memory 205 in the form of various data structures. Additionally, the aforementioned data can be organized using data models, such as relational or hierarchical data models. The other data 215 may be used to store data, including temporary data and temporary files, generated by modules for performing the various functions of the functionality detection unit 201.

In an embodiment, the event data 214 comprises information of internal triggers and the external triggers. The internal triggers are the events which are generated within the primary electronic appliance. As an example, the internal triggers may include, but are not limited to, initialization of the system, data associated with one or more sensors and events from device business logic. The external triggers are the events which are generated by the one or more secondary electronic appliances in the communication network 103. The external triggers may include, but are not limited to, system admin control command and hot plug of resources. As an example, the primary electronic appliance may receive the events from within and the one or more secondary electronic appliances for initializing the functionality detection unit 201 upon which the functionality detection unit 201 extends the functionality of the primary electronic appliance for performing one or more secondary functionalities as well.

In an embodiment, the property data 209 comprises information of one or more properties which is currently used by the primary electronic appliance for performing the primary functionality. The property data 209 provides a link between the primary electronic appliance and resources used by the primary electronic appliance for performing the one or more functions of the primary electronic appliance. As an example, the data associated with temperature provides a link between two electronic appliances 101 namely refrigerator and air conditioner.

In an embodiment, the device function data 211 comprises information of one or more functions capable of being performed by the primary electronic appliance. As an example, the functions of the primary electronic appliance namely an air conditioner may be cooling, displaying the room temperature and reducing the humidity of the air etc.

In an embodiment, the peer device function data 213 comprises information of one or more functions capable of being performed by the one or more secondary electronic appliances.

In an embodiment, the data stored in the memory 205 are processed by the modules of the functionality detection unit 201.

The modules may be stored within the memory 205 as shown in FIG. 2b. In an example, the modules, communicatively coupled to the processor 207 may also be present outside the memory 205.

In one implementation, the modules may include, for example, a receiving module 217, a function identification module 219, an analysis module 221, a processing module 223 and other modules 225. The other modules 225 may be used to perform various miscellaneous functionalities of the functionality detection unit 201. It will be appreciated that such aforementioned modules may be represented as a single module or a combination of different modules.

In an embodiment, the receiving module 217 is configured to receive data and events from the primary electronic appliance and the one or more secondary electronic appliances. The receiving module 217 is also configured to receive, information associated with one or more properties of the one or more secondary electronic appliances required for performing the one or more functions associated with the one or more secondary electronic appliances 101.

In an embodiment, the function identification module 219 is configured to identify the functions of the primary electronic appliance and the functions of the one or more secondary electronic appliances. The functions performed by the primary electronic appliance are stored in a function table configured in the primary electronic appliance. As an example, if the primary electronic appliance is an air conditioner then the one or more functions performed by the air conditioner are stored in the function table as shown below in Table 1. In an embodiment, the function identification module 219 also obtains the one or more functions associated with the one or more secondary electronic appliances and stores in a peer function table as shown below in Table 2. The functions performed by the one or more secondary electronic appliances are stored in a peer device function table configured in the primary electronic appliance. As an example, if the secondary electronic appliance is a refrigerator, then the one or more functions performed by the refrigerator are stored in the peer function table in Table 2.

TABLE 1
Function table

1. Conditioning air
2. Indicating room temperature
3. Reducing humidity of air

TABLE 2
Peer function table

1. Internal cooling
2. Providing warning signals

In an embodiment, the analysis module 221 unit is configured to compare the information associated with one or more properties and data required for performing the one or more functions associated with the primary electronic appliance with the information associated with one or more properties and data required for performing the one or more functions associated with the one or more secondary electronic appliances. Based on the comparison the analysis module 221 detects the similarity in the one or more properties data and functions of the primary electronic appliances corresponding to the properties data and functions of the one or more secondary electronic appliances.

In an embodiment, the processing module 223 is configured to identify the processing logic for performing the one or more functions of the one or more secondary electronic appliances once a similarity is detected in the properties, data and functions of the primary electronic appliance with the corresponding properties data and functions of the one or more secondary electronic appliances. The processing logic may be present within the primary electronic appliance or the processing module 223 may retrieve from one of one or more secondary electronic appliances with which the functions, data and properties have been matched. Once the required processing logic is received, the processing module 223 extends the functionality of the primary electronic appliance for performing the one or more secondary functionalities based on the processing logic.

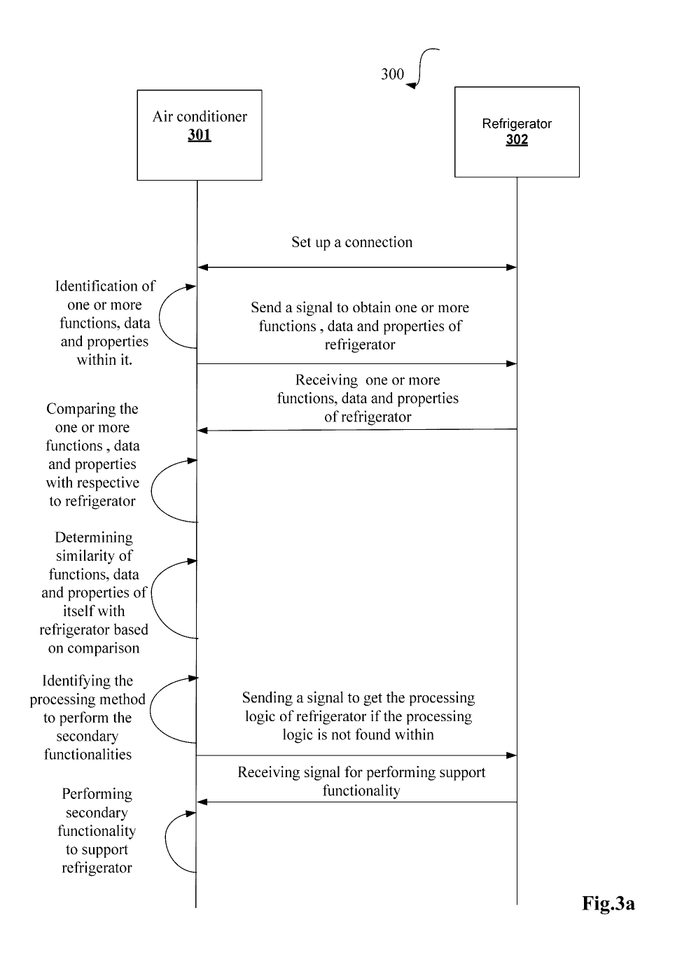

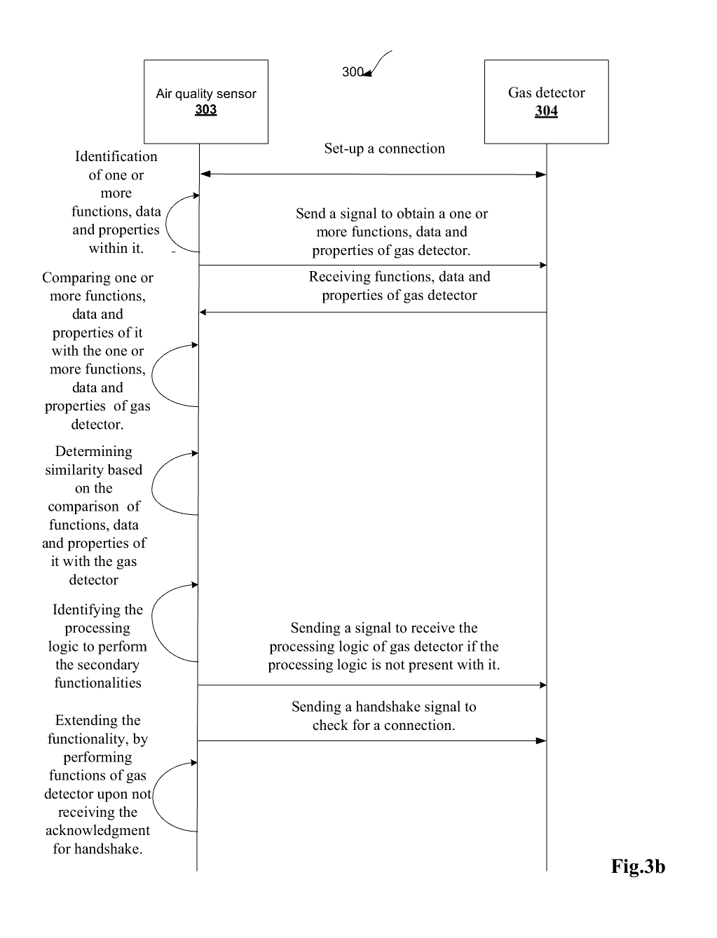

FIG. 3a shows a sequence diagram illustrating a method for extending the primary functionality of the primary electronic appliance in accordance with some exemplary embodiments of the present disclosure.

As shown in FIG. 3a two electronic appliances namely an air conditioner 301 and a refrigerator 302 are connected through the communication network 103. The air conditioner 301 is configured to condition the air and the refrigerator 302 is configured to provide cooling inside the refrigerator 302. So, the primary functionality of the air conditioner 301 is to condition the room temperature and the primary functionality of the refrigerator 302 is to provide cooling inside the refrigerator 302. The function identification module 219 configured in the functionality detection unit 201 of the air refrigerator 302 identifies the one or more functions of the refrigerator 302. The one or more functions of the refrigerator 302 are providing cooling inside the refrigerator 302, providing warning signals for closing the door of the refrigerator 302 etc. Similarly, the one or more functions of the air conditioner 301 are conditioning the air, indicating room temperature, reduce the humidity of the air in a particular area. As an example, the air conditioner 301 and refrigerator 302 initially sets up a connection between each other. Once the connection is established, the refrigerator 302 identifies its own one or more functions and probes the air conditioner 301 to provide the information associated with the one or more functions and data and properties required for performing the one or more functions of the air conditioner 301. The air conditioner 301 provides information of the one or more functions, data and properties to the refrigerator 302. The analysis module 221 of the refrigerator 302 compares the functions, data and properties of the air conditioner 301 with the functions, properties and data of the air conditioner 301. As an example, the functionality detection unit 201 of the refrigerator 302 may detect inefficient performance of the refrigerator 302 in terms of energy consumption. For example, the energy consumed by the refrigerator 302 for its operations at current room temperature may be x units. The refrigerator 302 identifies the optimal external temperature for efficient cooling inside the refrigerator 302. As an example, the current room temperature may be 25 degree Celsius. The optimal external temperature for efficient internal cooling may be 20 degree Celsius. The energy consumed by the refrigerator 302 for efficient internal cooling is more as being performed by the air conditioner 301. Therefore, the refrigerator 302 invokes the functionality of the air conditioner 301 to reduce the temperature from 25 to 20 degree Celsius thereby providing optimal cooling and energy utilization.

FIG. 3b shows a sequence diagram illustrating a method of providing support for performing the secondary functionalities by a primary electronic appliance in accordance with some exemplary embodiments of the present disclosure.

As shown in FIG. 3b, two electronic appliances 101, namely an air quality sensor 303 and a gas detector 304 are connected through the communication network 103. The air quality sensor 303 is configured to detect the quality of air in the surrounding and the gas detector 304 is configured to detect the presence of gas leakage. So the primary functionality of the air quality sensor 303 is detecting the quality of air and the primary functionality of gas detector 304 is to detect any gas leakage. The function identification module 219 configured in the air quality sensor 303 identifies the functions of the air quality sensor. The functions of the air quality sensor 304 may be detecting the quality of air, measuring the concentration of gases in the air etc. Similarly, the functions of the gas detector 304 are detecting any gas leakage, indicating the concentration of gases etc. As an example, the air quality sensor 303 and gas detector 304 initially sets up a connection between each other. Once the connection is established, the air quality sensor 303 identifies its own one or more functions and also probes the gas detector 304 to provide the information associated with the one or more function of the gas detector 304. The gas detector 304 provides information of the one or more functions, to the air quality sensor. The analysis module 221 of the air quality sensor 303 compares the functions, data and properties of the air quality sensor 303 with the gas detector 304. The processing module 223 of the air quality sensor 303 checks the availability of the processing logic to perform the secondary functionality of detecting the gas leakage. If the processing logic is not available in the air quality sensor 303, the air quality sensor 303 receives the information associated with the processing logic from the gas detector 304.

The air quality sensor 303 and the gas detector 304 on predefined time intervals exchange handshake signals to detect whether the electronic appliances 101 are working or not. As an example, the air quality sensor 303 has not received an acknowledgement from the gas detector 304 for the handshake signal upon which the air quality sensor 303 detects failure of the gas detector 304. Hence the air quality sensor 303 performs the secondary functionality of detecting a gas leakage which was the primary functionality of the gas detector 304.

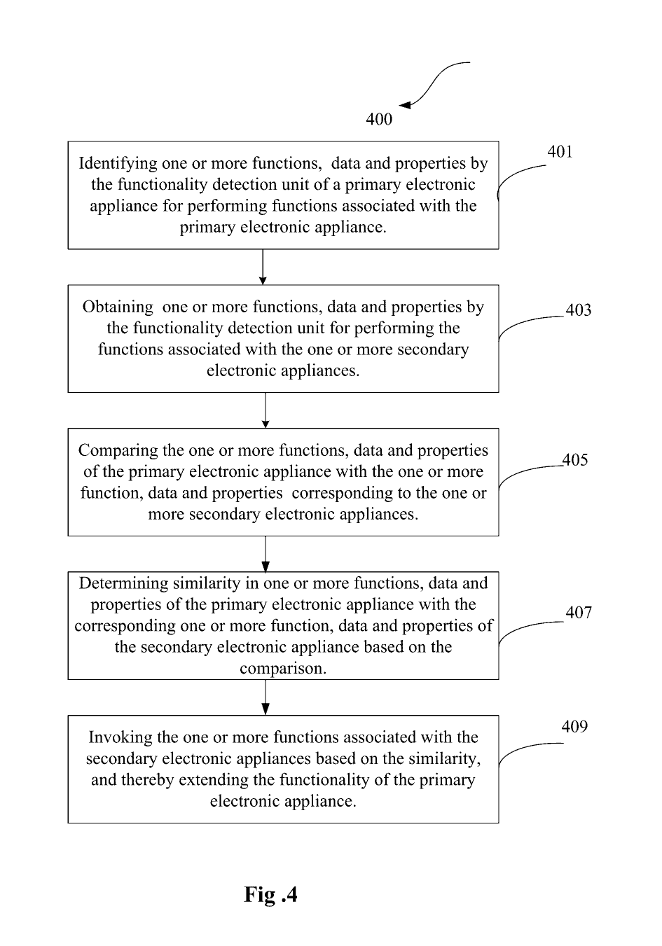

FIG. 4 illustrates a flowchart showing the method for extending the functionality of the primary electronic appliance in accordance with some embodiments of present disclosure. As illustrated in FIG. 4, the method 400 comprises one or more blocks for extending the functionality of the primary electronic appliance interconnected with the one or more secondary electronic appliances using a functionality detection unit 201. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, one or more functions of the primary electronic appliance and information associated with one or more properties and data required for performing the one or more functions associated with the primary electronic appliance are identified by the function identification module 219 of the functionality detection unit 201. The information of the one or more functions associated with the primary electronic device and the properties and the data are stored in the function list table of the primary electronic appliance.

At block 403, obtaining one or more function associated with the one or more secondary electronic appliances and information associated with one or more properties and data required for performing the one or more functions associated with the one or more secondary electronic appliances is determined by the function identification module 219 of the functionality detection unit 201. The information of the one or more functions, data and properties corresponding to the one or more secondary electronic appliances are stored in a peer function list table which is configured in the primary electronic appliances. The peer function table is updated when the one or more secondary electronic appliances are identified in the communication network 103.

At block 405, the one or more functions, data and properties associated with the primary electronic appliance is compared with the one or more functions, data and the properties corresponding to the one or more secondary electronic appliances. The comparison is performed by the analysis module 221 of the functionality detection unit 201

At block 407, the analysis module 221 of the primary electronic appliance determines similarity in the properties and data associated with the primary electronic appliance with the one or more data and properties of the corresponding one or more secondary electronic appliances.

At block 409, the processing module 223 checks for the availability of the processing logic to perform the secondary functionality of the one or more secondary electronic appliance upon detecting the similarities in the properties data and functions of the primary electronic appliances with the corresponding properties data and functions of the one or more secondary electronic appliances. If the processing logic is not available within the primary electronic appliance the processing module 223 of the primary electronic appliance receives it from the secondary electronic appliances. Upon receiving the processing logic the processing module 223 invokes the one or more functions associated with the secondary electronic appliances based on the similarity, and thereby extends the functionality of the primary electronic appliance.

### Electronic Appliance

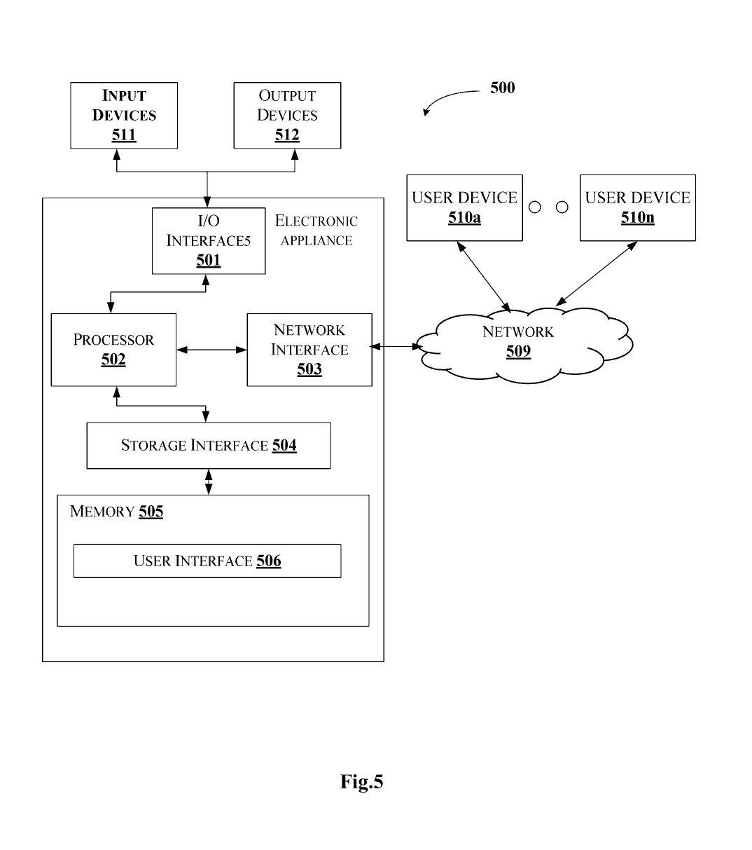

FIG. 5 illustrates a block diagram of an exemplary electronic appliance for implementing embodiments consistent with the present disclosure. In an embodiment, the electronic Appliance 500 is used for performing the one or more secondary functionalities using functionality detection unit 201. The electronic appliance 500 may comprise a central processing unit (“CPU” or “processor”) 502.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 501, the electronic appliance 500 may communicate with one or more I/O devices (511 and 512).

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11 a/b/g/n/x, etc. Using the network interface 503 and the communication network 509, the electronic appliance 500 may communicate with one or more user devices 510 (a, . . . n). The communication network 509 can be implemented as one of the different types of networks, such as intranet or Local Area Network (LAN) and such within the home or organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc. The one or more user devices 510 (a, . . . , n) may include, without limitation, personal computer(s), mobile devices such as cellular telephones, smartphones, tablet computers, eBook readers, laptop computers, notebooks, gaming consoles, or the like.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface application 506, an operating system 507, web server 508 etc. In some embodiments, computer system 500 may store user/application data 506, such as the data, variables, records, etc. as described herein. Such databases may be implemented as fault-tolerant, relational, scalable, secure databases such as Oracle or Sybase.

Furthermore, one or more computer-readable storage media may be utilized in implementing embodiments consistent with the present technology. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

### Advantages of the Embodiment of the Present Disclosure are Illustrated Herein.

In an embodiment, the present disclosure provides a method for extending the functionality of primary electronic appliances for performing one or more functionalities in a communication network.

In an embodiment, the present disclosure provides a method to support the primary electronic appliances upon detecting similarity in the functions between the one or more secondary electronic appliances.

In an embodiment, the present disclosure provides a method wherein, primary electronic appliance can perform the secondary functionalities upon detecting the failure of one or more secondary electronic appliances.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of this technology need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present technology are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for extending functionality of primary electronic appliances inter-connected with secondary electronic appliances in communication networks, the method comprising:
identifying, by a functionality detection computing device, a first set of one or more functions associated with the primary electronic appliance and information associated with one or more properties of, and data required for performing, the first set of functions;
obtaining, by the functionality detection computing device, a second set of one or more functions associated with one or more secondary electronic appliances and information associated with one or more properties of, and data required for performing, the second set of functions;
comparing, by the functionality detection computing device, the information associated with the one or more properties of, and data required for performing, the first set of functions with the information associated with one or more properties of, and data required for performing, the second set of functions associated;
determining, by the functionality detection computing device, similarity in the information associated with one or more properties of, and data required for performing, the first set of functions with the information associated with one or more properties of, and data required for performing, the second set of functions based on the comparison; and
invoking, by the functionality detection computing device, the second set of functions based on the similarity to extend functionality of the primary electronic appliance.

2. The method as claimed in claim 1 further comprising obtaining, by the functionality detection computing device, information associated with one or more processing logics for performing the second set of functions.

3. The method as claimed in claim 1, wherein the invoking further comprises detecting performance of the first set of functions below a threshold.

4. The method as claimed in claim 3, wherein the performance below the threshold is detected based on energy consumption, processing capacity, storage capacity, or one or more communication network resources.

5. The method as claimed in claim 1, wherein the first set of functions are listed in a function list table or the second set of functions are included in a peer resource table.

6. A functionality detection computing device, comprising a memory coupled to a processor and storing executable instructions that comprise and, when executed by the processor, cause the processor to:
identify a first set of one or more functions associated with the primary electronic appliance and information associated with one or more properties of, and data required for performing, the first set of functions;
obtain a second set of one or more functions associated with one or more secondary electronic appliances and information associated with one or more properties of, and data required for performing, the second set of functions;
compare the information associated with the one or more properties of, and data required for performing, the first set of functions with the information associated with one or more properties of, and data required for performing, the second set of functions associated;
determine similarity in the information associated with one or more properties of, and data required for performing, the first set of functions with the information associated with one or more properties of, and data required for performing, the second set of functions based on the comparison; and
invoke the second set of functions based on the similarity to extend functionality of the primary electronic appliance.

7. The functionality detection computing device as claimed in claim 6, wherein the executable instructions further comprise and, when executed by the processor, cause the processor to obtain information associated with one or more processing logics for performing the second set of functions.

8. The functionality detection computing device as claimed in claim 6, wherein the executable instructions further comprise and, when executed by the processor, cause the processor to detect performance of the first set of functions below a threshold.

9. The functionality detection computing device as claimed in claim 8, wherein the performance below the threshold is detected based on energy consumption, processing capacity, storage capacity, or one or more communication network resources.

10. The functionality detection computing device as claimed in claim 6, wherein the first set of functions are listed in a function list table or the second set of functions are included in a peer resource table.

11. A non-transitory computer readable medium comprising instructions stored thereon for extending functionality of primary electronic appliances inter-connected with secondary electronic appliances in communication networks, which when executed by at least one processor, cause the processor to perform operations comprising:
identifying a first set of one or more functions associated with the primary electronic appliance and information associated with one or more properties of, and data required for performing, the first set of functions;
obtaining a second set of one or more functions associated with one or more secondary electronic appliances and information associated with one or more properties of, and data required for performing, the second set of functions;
comparing the information associated with the one or more properties of, and data required for performing, the first set of functions with the information associated with one or more properties of, and data required for performing, the second set of functions associated;
determining similarity in the information associated with one or more properties of, and data required for performing, the first set of functions with the information associated with one or more properties of, and data required for performing, the second set of functions based on the comparison; and
invoking the second set of functions based on the similarity to extend functionality of the primary electronic appliance.

12. The non-transitory computer readable medium as claimed in claim 11, wherein the instructions, when executed by the processor, further cause the processor to perform one or more additional operations comprising obtaining information associated with one or more processing logics for performing the second set of functions.

13. The non-transitory computer readable medium as claimed in claim 11, wherein the instructions, when executed by the processor, further cause the processor to perform one or more additional operations comprising detecting performance of the first set of functions below a threshold.

14. The non-transitory computer readable medium as claimed in claim 13, wherein the performance below the threshold is detected based on energy consumption, processing capacity, storage capacity, or one or more communication network resources.

15. The non-transitory computer readable medium as claimed in claim 11, wherein the first set of functions are listed in a function list table or the second set of functions are included in a peer resource table.
